(19) United States
(12) Patent Application Publication
(10) Pub. No.: US 2014/0092962 A1
(43) Pub. Date: Apr. 3, 2014

(54) INTER FIELD PREDICTIONS WITH HEVC

(71) Applicant: SONY CORPORATION, Tokyo (JP)

(72) Inventor: Cheung Auyeung, Sunnyvale, CA (US)

(21) Appl. No.: 13/793,927

(22) Filed: Mar. 11, 2013

Related U.S. Application Data
(60) Provisional application No. 61/708,345, filed on Oct. 1, 2012.

(51) Int. Cl. H04N 7/36

(52) U.S. Cl. CPC H04N 19/00575
USPC 375/240.12

(57) ABSTRACT

To improve the coding efficiency of field sequences, any GOP structures for field sequence coding by HEVC have both top and bottom fields in a reference list. Modified HEVC inter-field prediction uses an interlaced video with a series of frames. Each interlaced frame is separated into a top field and a bottom field. For HEVC encoding, inter-field prediction structures are defined with the following properties: if a current block in a picture includes only pixels in a field and it has more than one reference field pictures as reference pictures in a reference list, then at least one of the reference field pictures comes from the top field of a frame and at least one of the reference field pictures comes from the bottom field of a frame.

CROSS-REFERENCE TO RELATED APPLICATION(S)

This application claims priority under 35 U.S.C. §119(e) of the U.S. Provisional Patent Application Ser. No. 61/708,345, filed Oct. 1, 2012 and titled, “INTER FIELD PREDICTIONS WITH HEVC,” which is hereby incorporated by reference in its entirety for all purposes.

### FIELD OF THE INVENTION

The present invention relates to the field of video encoding. More specifically, the present invention relates to high efficiency video coding.

### BACKGROUND OF THE INVENTION

For encoding interlaced video by HEVC version 1, a video sequence is only able to be encoded entirely as a frame structured video or entirely as a field structure video. HEVC version 1 is not able to have both field structure pictures and frame structure pictures in a sequence, e.g., HEVC version 1 is not able to mix field picture and frame picture coding in a sequence. However, a video clip is able to be segmented into multiple sequences. Each sequence is able to either be encoded exclusively in field structure picture or exclusively in frame structure picture. Switching frame and field at the sequence level adds complexity to the encoder. Optimal switching between frame and field coding would cause each sequence to be encoded two times and the best picture structure to be selected.

### SUMMARY OF THE INVENTION

To improve the coding efficiency of field sequences, any GOP structures for field sequence coding by HEVC have both top and bottom fields in a reference list. Modified HEVC inter-field prediction uses an interlaced video with a series of frames. Each interlaced frame is separated into a top field and a bottom field. For HEVC encoding, inter-field prediction structures are defined with the following properties: if a current block in a picture includes only pixels in a field and it has more than one reference field pictures as reference pictures, then at least one of the reference field pictures comes from the top field of a frame and at least one of the reference field pictures comes from the bottom field of a frame.

In one aspect, a method of performing inter field prediction programmed in a memory of a device comprises separating each interlaced frame of an interlaced video into a top field and a bottom field and encoding the interlaced video using a modified group of pictures structure including a top field and a bottom field in a reference list with a plurality of reference pictures. If a current block in a picture includes only pixels in a field and the block has a plurality of reference field pictures in a reference picture list, then at least one of the reference field pictures is from the top field of a frame and at least one of the reference field pictures is from the bottom field of the frame or another frame. The reference field pictures of a current picture in a reference picture list closest in time to the current picture include a top field picture and a bottom field picture. The modified group of pictures structure applies to high efficiency video coding version 1 when all pictures in a sequence are field structure pictures. The modified group of pictures structure applies to high efficiency video coding extensions or other versions of high efficiency video coding for field picture or field block coding where a current picture is a field structured picture, or the current picture is a frame structured picture and the current block is encoded as two field blocks. The modified group of pictures structure is used for random access field sequences. The modified group of pictures structure is used for low delay field sequences. The modified group of pictures structure for random access field sequences has a group of pictures size of 16 field pictures. The two nearest reference pictures of the current picture which are before the current picture, if available, include a top field picture and a bottom field picture. The two nearest reference pictures of the current picture which are after the current picture, if available, include a top field picture and a bottom field picture. The modified group of pictures structure for low delay field sequences has a group of pictures size of 8 field pictures. The modified group of pictures structure comprises an alternative modified group of pictures structure for random access field sequences has a group of pictures size of 16 field pictures. The modified group of pictures structure comprises a breadth-first modified group of pictures structure for random access field sequences has a group of pictures size of 16 field pictures. The method further comprises allocating additional memory to support the modified GOP structures to support a longer reference picture list.

In another aspect, a system for performing inter field prediction programmed in a memory of a device comprises a separating module configured for separating each interlaced frame of an interlaced video into a top field and a bottom field and an encoding module configured for encoding the interlaced video using a modified group of pictures structure including a top field and a bottom field in a reference list with a plurality of reference pictures. If a current block in a picture includes only pixels in a field and the block has a plurality of reference field pictures as reference pictures in a reference picture list, then at least one of the reference field pictures is from the top field of a frame and at least one of the reference field pictures is from the bottom field of the frame or another frame. The reference field pictures of a current picture in a reference picture list closest in time to the current picture include a top field picture and a bottom field picture. The modified group of pictures structure applies to high efficiency video coding version 1 when all pictures in a sequence are field structure pictures. The modified group of pictures structure applies to high efficiency video coding extensions or other versions of high efficiency video coding for field picture or field block coding where a current picture is a field structured picture, or the current picture is a frame structured picture and the current block is encoded as two field blocks. The modified group of pictures structure is used for random access field sequences. The modified group of pictures structure is used for low delay field sequences. The modified group of pictures structure for random access field sequences has a group of pictures size of 16 field pictures. The two nearest reference pictures of the current picture which are before the current picture, if available, include a top field picture and a bottom field picture. The two nearest reference pictures of the current picture which are after the current picture, if available, include a top field picture and a bottom field picture. The modified group of pictures structure for low delay field sequences has a group of pictures size of 8 field pictures. The modified group of pictures structure comprises an alternative modified group of pictures structure for random access field sequences has a group of pictures size of 16 field pictures. The modified group of pictures structure comprises a breadth-first modified group of pictures structure for random access field sequences has a group of pictures size of 16 field pictures. The system further comprises a memory module configured for allocating additional memory to support the modified GOP structures to support a longer reference picture list.

In another aspect, an apparatus comprises a non-transitory memory for storing an application, the application for: a separating module configured for separating each interlaced frame of an interlaced video into a top field and a bottom field and an encoding module configured for encoding the interlaced video using a modified group of pictures structure including a top field and a bottom field in a reference list with a plurality of reference pictures and a processing component coupled to the memory, the processing component configured for processing the application. If a current block in a picture includes only pixels in a field and the block has a plurality of reference field pictures as reference pictures in a reference list, then at least one of the reference field pictures is from the top field of a frame and at least one of the reference field pictures is from the bottom field of the frame or another frame. The reference field pictures of a current picture in a reference list closest in time to the current picture include a top field picture and a bottom field picture. The modified group of pictures structure applies to high efficiency video coding version 1 when all pictures in a sequence are field structure pictures. The modified group of pictures structure applies to high efficiency video coding extensions or other versions of high efficiency video coding for field picture or field block coding where a current picture is a field structured picture, or the current picture is a frame structured picture and the current block is encoded as two field blocks. The modified group of pictures structure is used for random access field sequences. The modified group of pictures structure is used for low delay field sequences. The modified group of pictures structure for random access field sequences has a group of pictures size of 16 field pictures. The two nearest reference pictures of the current picture which are before the current picture, if available, include a top field picture and a bottom field picture. The two nearest reference pictures of the current picture which are after the current picture, if available, include a top field picture and a bottom field picture. The modified group of pictures structure for low delay field sequences has a group of pictures size of 8 field pictures. The modified group of pictures structure comprises an alternative modified group of pictures structure for random access field sequences has a group of pictures size of 16 field pictures. The modified group of pictures structure comprises a breadth-first modified group of pictures structure for random access field sequences has a group of pictures size of 16 field pictures. The apparatus further comprises allocating additional memory to support the modified GOP structures to support a longer reference picture list.

### BRIEF DESCRIPTION OF THE DRAWINGS

FIG. 1 shows the reference picture list of the random access GOP structure specified in the Common Test Condition (CTC) configuration files.

FIG. 2 shows the reference picture list of the low delay GOP structure specified in the CTC configuration files.

FIG. 3 shows a modified GOP structure used for random access field sequences.

FIG. 4 shows a modified GOP structure used for low delay field sequences.

FIG. 5 shows an alternative modified GOP structure for random access field sequences.

FIG. 6 shows a breadth-first modified GOP structure for random access field sequences.

FIG. 7 shows a modified GOP structure for random access configuration files and a modified GOP structure for low delay configuration files according to some embodiments.

FIG. 8 shows a flowchart of a method of performing inter field prediction according to some embodiments.

FIG. 9 shows a block diagram of an exemplary computing device configured to implement the method of performing inter field prediction according to some embodiments.

FIG. 10 shows a general diagram of an HEVC encoder according to some embodiments.

FIG. 11 shows a general diagram of an HEVC decoder according to some embodiments.

### DETAILED DESCRIPTION OF THE PREFERRED EMBODIMENT

In High Efficiency Video Coding (HEVC) version 1, the coding efficiency of HEVC test Model 6.2 (HM6.2) for coding interlaced video in frame sequence was compared with coding interlaced video in field sequence in random access configuration with a Group of Pictures (GOP) size of 8. The GOP structure used in the comparisons is the common test conditions GOP structure except that the IntraPeriod was 96 for field sequences and 48 for frame sequences. HEVC version 1 demonstrated that some sequences, such as Mobile and Calendar, are significantly better to be encoded in frame sequence. And some sequences such as F1car are significantly better to be encoded in field sequence.

The performance of HM8.0 for coding interlaced video in frame sequence and in field sequence is compared with the 9 MPEG2 test sequences. The common test conditions GOP structures are used in the comparison where IntraPeriod is approximately one second for frame sequences and field sequences. In particular, a GOP size of 8 is used for random access configurations, and a GOP size of 4 is used for low delay configurations.

In HM8 Common Test Configuration (CTC), the coding efficiency of field structure is not robust. Some pictures are more efficiently encoded in field structure, and some pictures are less efficiently coded in field structure. The inter field predictions with the modified GOP structures are more robust than the CTC GOP structure. When frame structure coding is better, the difference in coding efficiency is reduced between field structure coding and frame structure coding. When field structure coding is better, the improvements of field structure coding is maintained.

Modified GOP structures for encoding video by HM in field sequences are described herein. For the 9 MPEG2 test sequences, when a video is more efficiently encoded in fields than in frames, the modified GOP structures maintain the coding efficiency of fields. When a video is less efficiently encoded in fields than in frames, the modified GOP structures reduce the coding efficiency gap between field sequence and frame sequence.

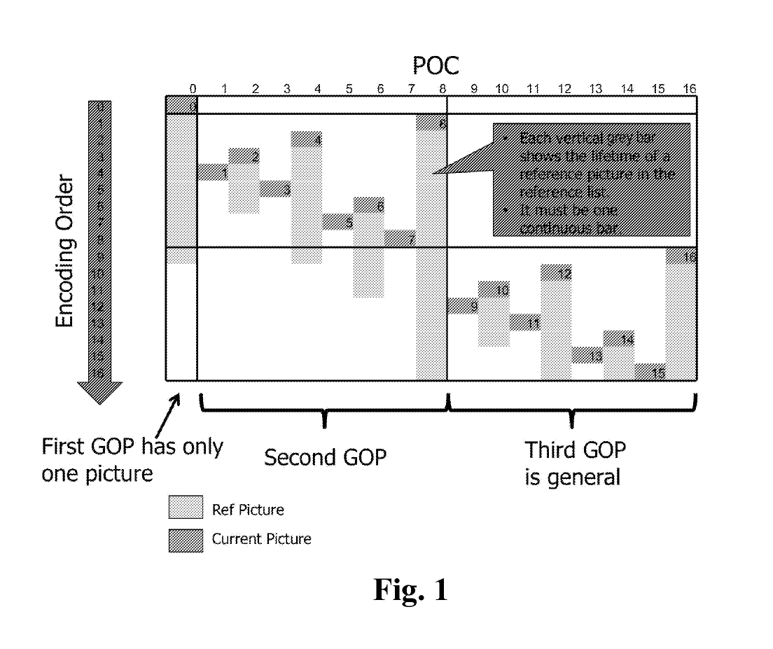

FIG. 1 shows the reference picture list of the random access GOP structure specified in the Common Test Condition (CTC) configuration files with the Picture Order Count (POC) in consecutive order. In some embodiments, the reference picture list of the random access GOP structure specified in the CTC configuration files with the POC is not in consecutive order. In each row, the box 100 in dark gray represents the current picture. The number inside the box 100 is the POC of the current picture. The boxes 102 in light gray in the same row are the corresponding pictures in the reference picture list. For example, at encoding order 2, the reference picture list of the current picture POC 4 is {POC 0, POC 8}. At encoding order 3, the reference list of the current picture POC 2 is {POC 0, POC 4, POC 8}. At encoding order 4, the reference list of the current picture POC 1 is {POC 0, POC 2, POC 4, POC 8}, but only POC 0, POC 2, POC 4 are active. The GOP structure has 8 pictures. The reference list in the second GOP is general, and it is used to define the reference pictures in the configuration files of the HM software, encoder_randomaccess_main.cfg and encoder randomaccess_he10.cfg.

One issue with the CTC random access GOP structure for field sequence coding is that all reference pictures are even POC pictures. In other words, odd fields are not able to be predicted from any odd field.

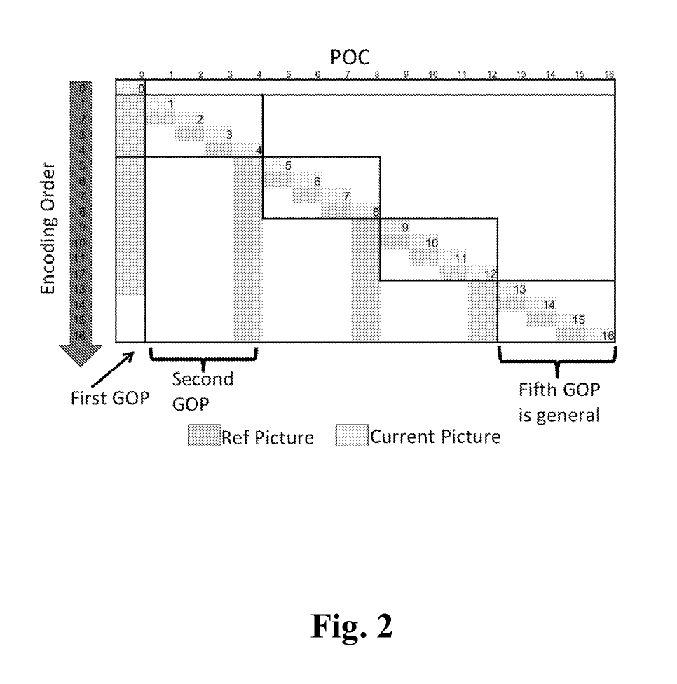

Similarly, FIG. 2 shows the reference picture list of the low delay GOP structure specified in the CTC configuration files. It has a GOP size of 4 pictures. The reference list in the fifth GOP is general, and it is used to define the reference pictures in encoder_lowdelay_main.cfg, encoder_lowdelay_he10.cfg, encoder_lowdelay_P_main.cfg, and encoder_lowdelay_P_he10.cfg.

One issue with the CTC low delay GOP structure for field sequence coding is that the reference picture list of an odd POC picture has only even POC pictures. In other words, odd fields are not able to be predicted from any odd field.

Modified HEVC inter-field prediction uses an interlaced video with a series of frames. Each interlaced frame is separated into a top field and a bottom field. For HEVC encoding, all inter-field prediction structures are defined with the following properties: if a current block in a picture includes only pixels in a field and it has more than one reference field pictures in a reference picture list as reference pictures, then at least one of the reference field pictures comes from the top field of a frame and at least one of the reference field pictures comes from the bottom field of a frame. For better performance, the two reference pictures in a reference picture list of a current picture closest in time to the current picture include a top field picture and a bottom field picture. The modified GOP structures apply to HEVC version 1 when all pictures in a sequence are field structure pictures. The modified inter-pictures prediction GOP structures apply to HEVC extensions or other versions of HEVC for field picture or field block coding where the current picture is a field structured picture, and the current picture is a frame structured picture and the current block is encoded as two field blocks.

As described herein, to improve the coding efficiency of field sequences, any GOP structures for field sequence coding by HEVC have both even and odd fields in the reference list.

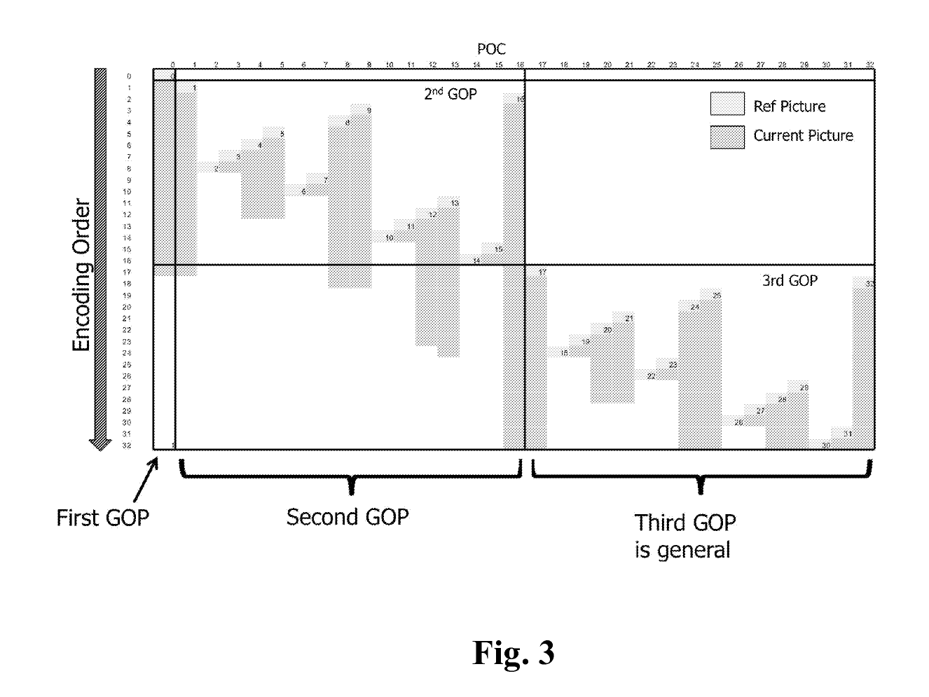

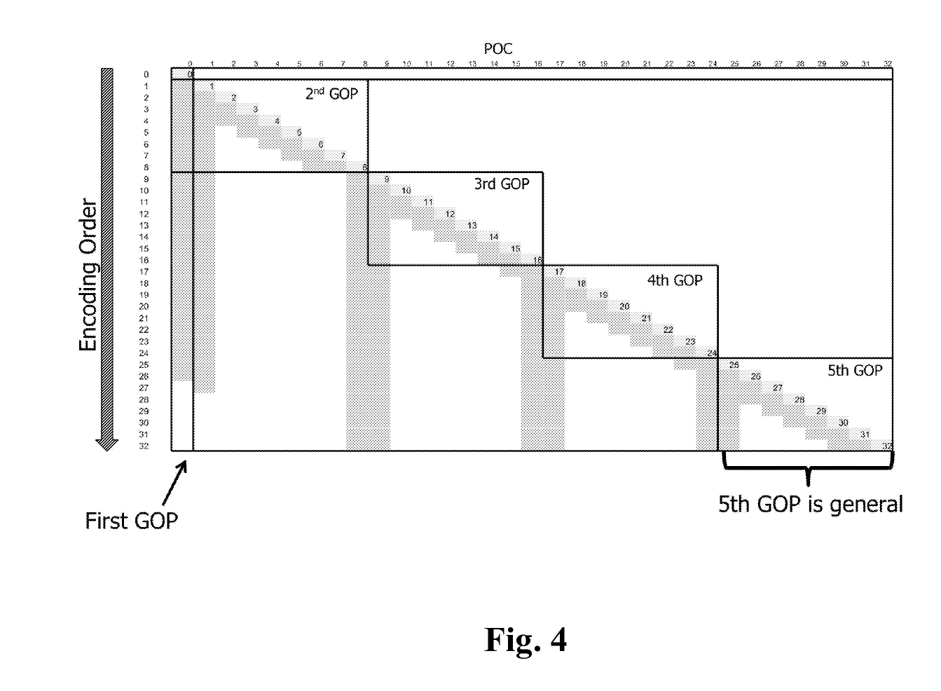

In particular, the GOP structure in FIG. 3 is used for random access field sequences, and the GOP structure in FIG. 4 is used for low delay field sequences.

As shown in FIG. 3, the modified GOP structure for random access field sequences has a GOP size of 16 field pictures. In contrast, the CTC GOP structure for random access field sequence has a GOP size of 8 pictures. The nearest two pictures before the current picture, if available, include an even POC picture and an odd POC picture. The nearest two pictures after the current picture, if available, include an even POC picture and an odd POC picture.

As shown in FIG. 4, the modified GOP structure for low delay field sequences has a GOP size of 8 field pictures. In contrast, the CTC GOP structure for low delay field sequence has a GOP size of 4 pictures.

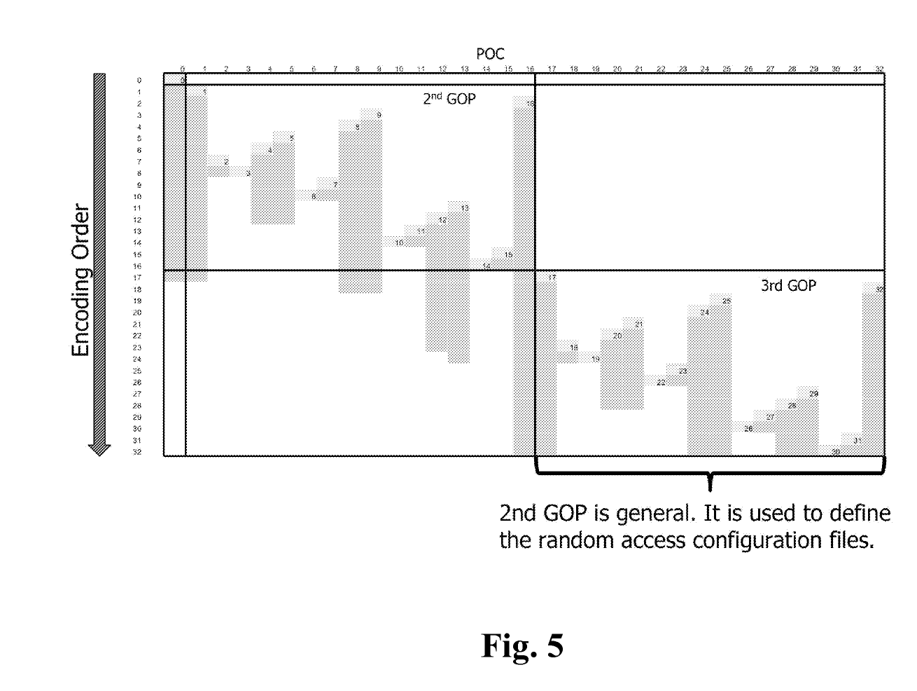

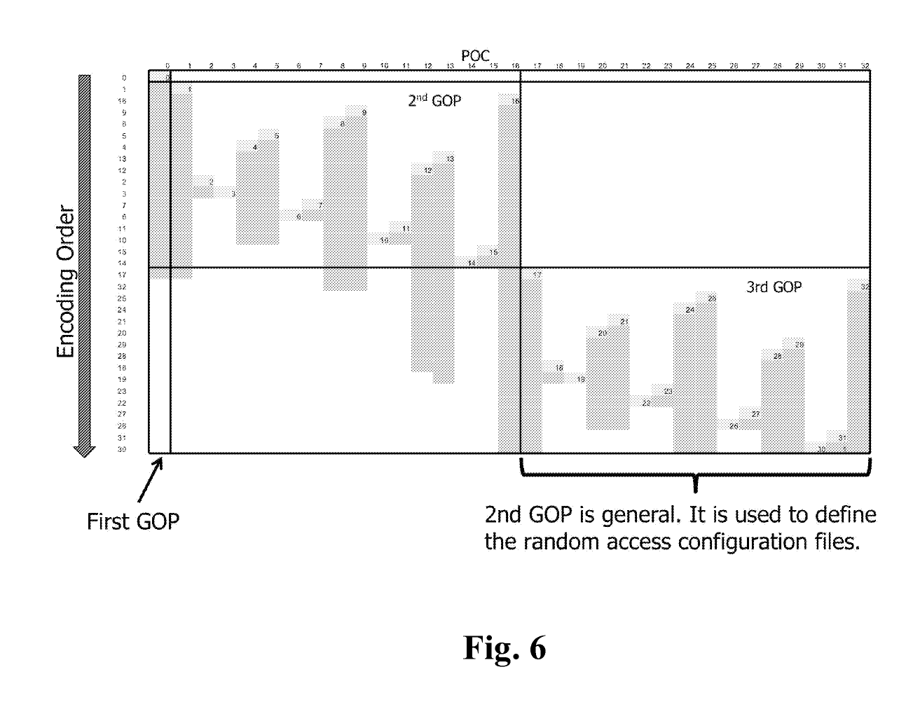

FIG. 5 shows an alternative modified GOP structure for random access field sequences. The GOP size is 16 field pictures. FIG. 6 shows a breadth-first modified GOP structure for random access field sequences. The GOP size is 16 field pictures.

Since the modified GOP structures have twice the number of reference pictures in the reference picture list as the corresponding CTC GOP structures, the HM8.0 ran into memory allocation problems. In order for HM8.0 to support the modified GOP structures, more memory was allocated to HM8.0 to support longer reference picture list. No other changes were made to HM8.0.

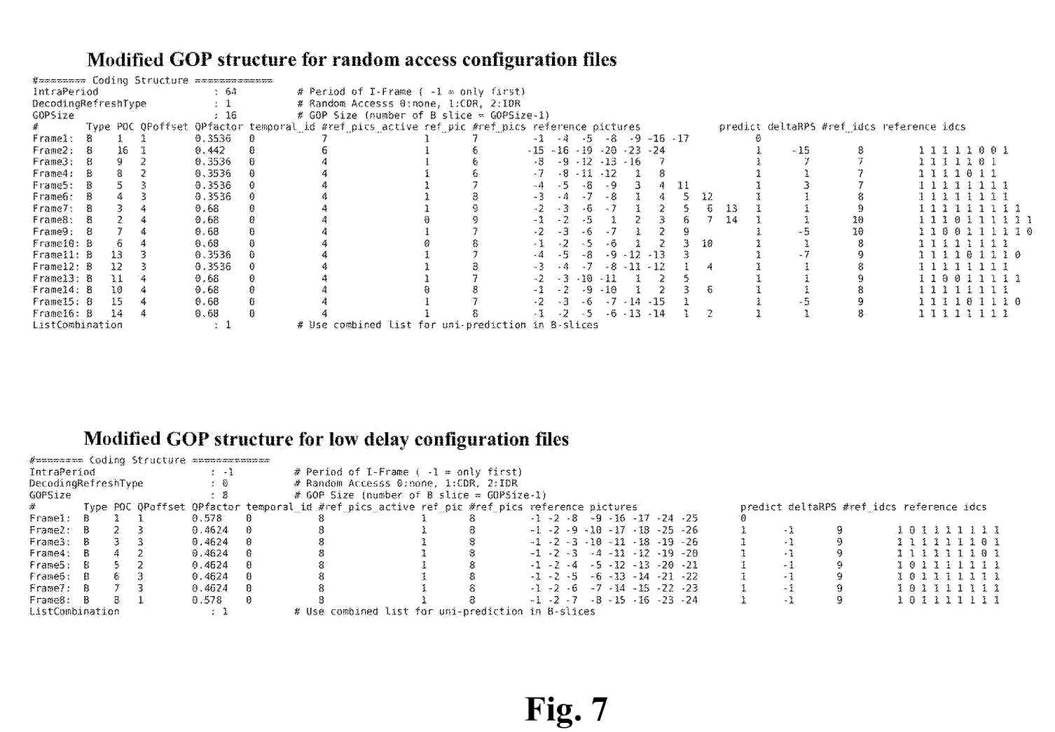

FIG. 7 shows a modified GOP structure for random access configuration files and a modified GOP structure for low delay configuration files according to some embodiments.

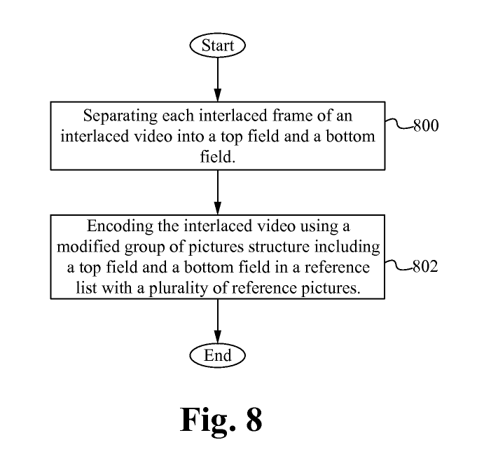

FIG. 8 illustrates a flowchart of a method of performing inter field prediction according to some embodiments. In the step 800, interlaced frames of an interlaced video is separated into a top field and a bottom field. In the step 802, the interlaced video is encoded using a modified group of pictures structure including a top field and a bottom field in a reference list. If a current block in a picture includes only pixels in a field and the block has a plurality of reference field picture as reference pictures in a first reference picture list, then at least one of the reference field pictures is from the top field of a frame and at least one of the reference field pictures is from the bottom field of the frame. The two reference pictures in a second reference picture list of a current picture closest in time to the current picture include a top field picture and a bottom field picture. The modified group of pictures structure applies to high efficiency video coding version 1 when all pictures in a sequence are field structure pictures. The modified group of pictures structure applies to high efficiency video coding extensions or other versions of high efficiency video coding for field picture or field block coding where a current picture is a field structured picture, or the current picture is a frame structured picture and the current block is encoded as two field blocks. In some embodiments, the modified group of pictures structure is used for random access field sequences. In some embodiments, the modified group of pictures structure is used for low delay field sequences. In some embodiments, the modified group of pictures structure for random access field sequences has a group of pictures size of 16 field pictures. In some embodiments, the modified group of pictures structure includes nearest two pictures before a current picture, if available, and includes an even picture order count picture and an odd picture order picture. In some embodiments, the modified group of pictures structure includes nearest two pictures after the current picture, if available, and includes an even picture order count picture and an odd picture order count picture. In some embodiments, the modified group of pictures structure for low delay field sequences has a group of pictures size of 8 field pictures. In some embodiments, the modified group of pictures structure comprises an alternative modified group of pictures structure for random access field sequences has a group of pictures size of 16 field pictures. In some embodiments, the modified group of pictures structure comprises a breadth-first modified group of pictures structure for random access field sequences has a group of pictures size of 16 field pictures. In some embodiments, additional memory is allocated to support the modified GOP structures to support a longer reference picture list. In some embodiments, more or fewer steps are implemented. In some embodiments, the order of the steps is modified.

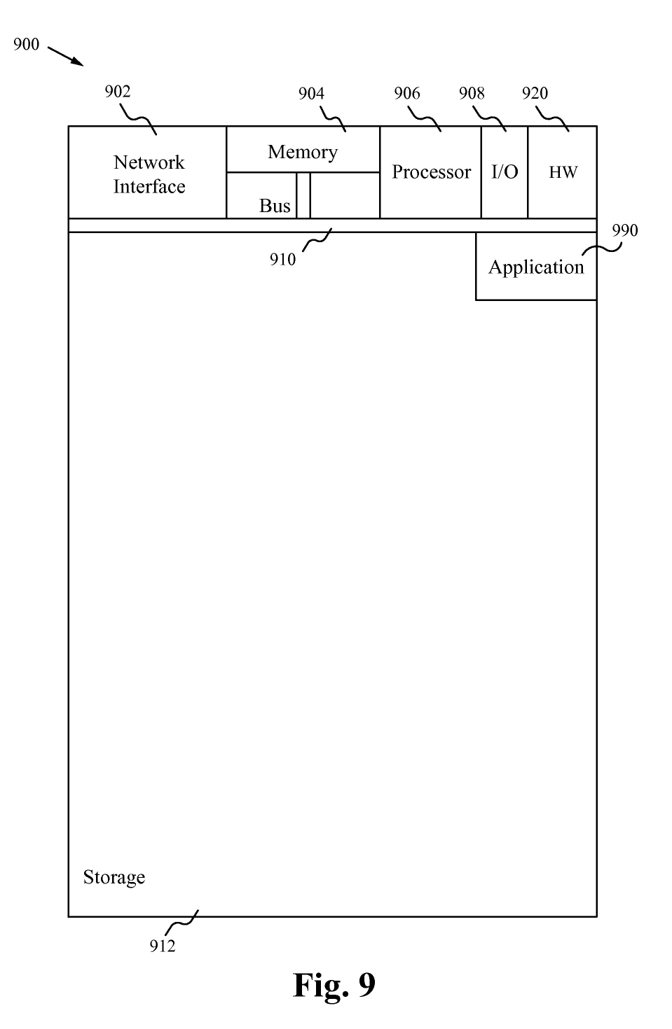

FIG. 9 illustrates a block diagram of an exemplary computing device configured to implement the method of performing inter field prediction according to some embodiments. The computing device 900 is able to be used to acquire, store, compute, process, communicate and/or display information such as images and videos. In general, a hardware structure suitable for implementing the computing device 900 includes a network interface 902, a memory 904, a processor 906, I/O device(s) 908, a bus 910 and a storage device 912. The choice of processor is not critical as long as a suitable processor with sufficient speed is chosen. The memory 904 is able to be any conventional computer memory known in the art. The storage device 912 is able to include a hard drive, CDROM, CDRW, DVD, DVDRW, Blu-ray®, flash memory card or any other storage device. The computing device 900 is able to include one or more network interfaces 902. An example of a network interface includes a network card connected to an Ethernet or other type of LAN. The I/O device(s) 908 are able to include one or more of the following: keyboard, mouse, monitor, screen, printer, modem, touchscreen, button interface and other devices. Inter field prediction application(s) 930 used to perform the inter field prediction method are likely to be stored in the storage device 912 and memory 904 and processed as applications are typically processed. More or less components shown in FIG. 9 are able to be included in the computing device 900. In some embodiments, inter field prediction hardware 920 is included. Although the computing device 900 in FIG. 9 includes applications 930 and hardware 920 for the inter field prediction method, the inter field prediction method is able to be implemented on a computing device in hardware, firmware, software or any combination thereof. For example, in some embodiments, the inter field prediction applications 930 are programmed in a memory and executed using a processor. In another example, in some embodiments, the inter field prediction hardware 920 is programmed hardware logic including gates specifically designed to implement the inter field prediction method.

In some embodiments, the inter field prediction application(s) 930 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

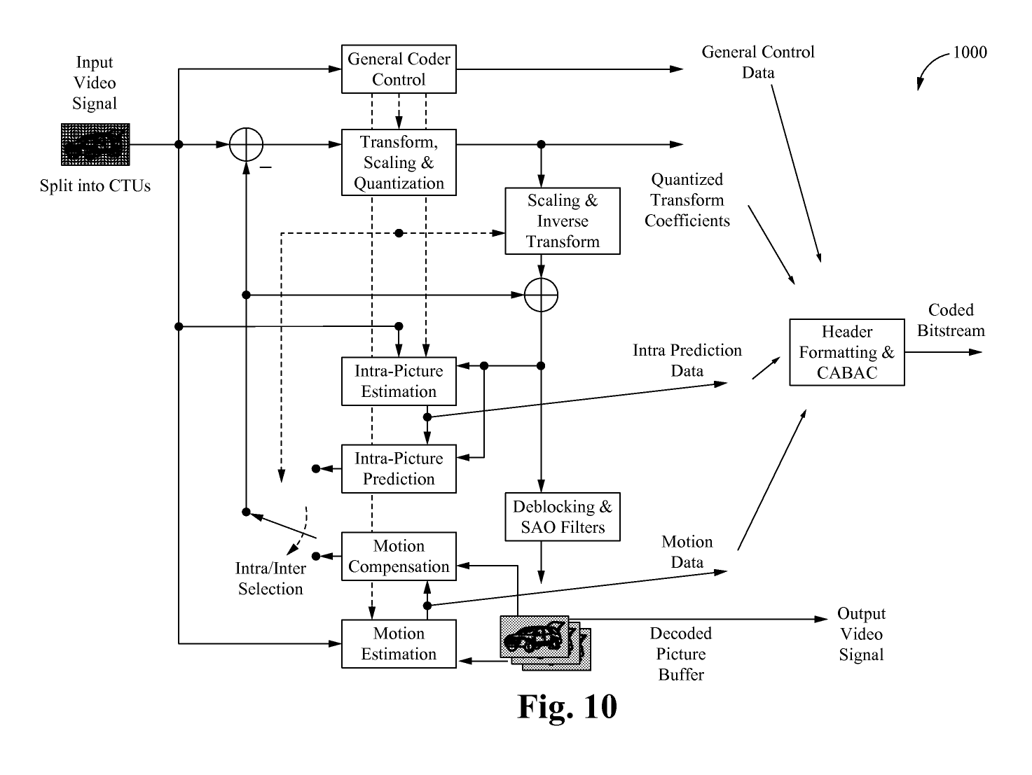

FIG. 10 illustrates a general diagram of an HEVC encoder according to some embodiments. The encoder 1000 includes a general coder control component, a transform scaling and quantization component, a scaling and inverse transform component, an intra-picture estimation component, a filter control analysis component, an intra-picture prediction component, a deblocking and SAO filters component, a motion compensation component, a motion estimation component, and a header formatting and CABAC component. An input video signal is received by the encoder 1000 and is split into Coding Tree Units (CTUs). The HEVC encoder components process the video data using the modified coding scheme and generate a coded bitstream.

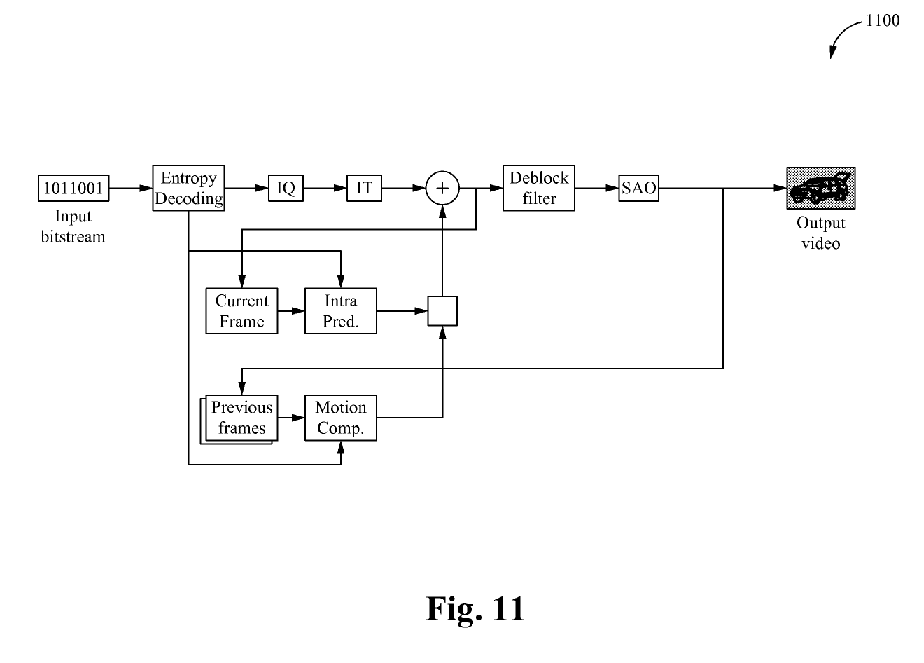

FIG. 11 illustrates a general diagram of an HEVC decoder according to some embodiments. The decoder 1100 includes an entropy decoding component, an inverse quantization component, an inverse transform component, a current frame component, an intra prediction component, a previous frames component, a motion compensation component, a deblocking filter, an SAO component and an adaptive loop filter. An input bitstream (e.g., a coded video) is received by the decoder 1100, and a decoded bitstream is generated for display. To utilize the inter field prediction method, a device such as a digital camera is able to be used to acquire a video. The inter field prediction method is automatically used when performing video processing. The inter field prediction method is able to be implemented automatically without user involvement.

In operation, the inter field prediction method improves coding efficiency of field sequences. When a video is more efficiently encoded in fields than in frames, the modified GOP structures maintain the coding efficiency of fields. When a video is less efficiently encoded in fields than in frames, the modified GOP structures reduce the coding efficiency gap between field sequence and frame sequence.

### Some Embodiments Of Inter Field Predictions with HEVC

1. A method of performing inter field prediction programmed in a memory of a device comprising:
   a. separating each interlaced frame of an interlaced video into a top field and a bottom field; and
   b. encoding the interlaced video using a modified group of pictures structure including a top field and a bottom field in a reference list with a plurality of reference pictures.
2. The method of clause 1 wherein if a current block in a picture includes only pixels in a field and the block has a plurality of reference field pictures in a reference picture list, then at least one of the reference field pictures is from the top field of a frame and at least one of the reference field pictures is from the bottom field of the frame or another frame.
3. The method of clause 2 wherein the reference field pictures of a current picture in a reference picture list closest in time to the current picture include a top field picture and a bottom field picture.
4. The method of clause 1 wherein the modified group of pictures structure applies to high efficiency video coding version 1 when all pictures in a sequence are field structure pictures.
5. The method of clause 1 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.
6. The method of clause 1 wherein the modified group of pictures structure is used for random access field sequences.
7. The method of clause 1 wherein the modified group of pictures structure is used for low delay field sequences.
8. The method of clause 1 wherein the modified group of pictures structure for random access field sequences has a group of pictures size of 16 field pictures.
9. The method of clause 8 wherein the two nearest reference pictures of the current picture which are before the current picture, if available, include a top field picture and a bottom field picture.
10. The method of clause 8 wherein the two nearest reference pictures of the current picture which are after the current picture, if available, include a top field picture and a bottom field picture.
11. The method of clause 1 wherein the modified group of pictures structure for low delay field sequences has a group of pictures size of 8 field pictures.
12. The method of clause 1 wherein the modified group of pictures structure comprises an alternative modified group of pictures structure for random access field sequences has a group of pictures size of 16 field pictures.
13. The method of clause 1 wherein the modified group of pictures structure comprises a breadth-first modified group of pictures structure for random access field sequences has a group of pictures size of 16 field pictures.
14. The method of clause 1 further comprising allocating additional memory to support the modified GOP structures to support a longer reference picture list.
15. A system for performing inter field prediction programmed in a memory of a device comprising:
   a. a separating module configured for separating each interlaced frame of an interlaced video into a top field and a bottom field; and
   b. an encoding module configured for encoding the interlaced video using a modified group of pictures structure including a top field and a bottom field in a reference list with a plurality of reference pictures.
16. The system of clause 15 wherein if a current block in a picture includes only pixels in a field and the block has a plurality of reference field pictures as reference pictures in a reference picture list, then at least one of the reference field pictures is from the top field of a frame and at least one of the reference field pictures is from the bottom field of the frame or another frame.
17. The system of clause 16 wherein the reference field pictures of a current picture in a reference picture list closest in time to the current picture include a top field picture and a bottom field picture.
18. The system of clause 15 wherein the modified group of pictures structure applies to high efficiency video coding version 1 when all pictures in a sequence are field structure pictures.
19. The system of clause 15 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.
20. The system of clause 15 wherein the modified group of pictures structure is used for random access field sequences.
21. The system of clause 15 wherein the modified group of pictures structure is used for low delay field sequences.
22. The system of clause 15 wherein the modified group of pictures structure for random access field sequences has a group of pictures size of 16 field pictures.
23. The system of clause 22 wherein the two nearest reference pictures of the current picture which are before the current picture, if available, include a top field picture and a bottom field picture.
24. The system of clause 22 wherein the two nearest reference pictures of the current picture which are after the current picture, if available, include a top field picture and a bottom field picture.
25. The system of clause 15 wherein the modified group of pictures structure for low delay field sequences has a group of pictures size of 8 field pictures.
26. The system of clause 15 wherein the modified group of pictures structure comprises an alternative modified group of pictures structure for random access field sequences has a group of pictures size of 16 field pictures.
27. The system of clause 15 wherein the modified group of pictures structure comprises a breadth-first modified group of pictures structure for random access field sequences has a group of pictures size of 16 field pictures.
28. The system of clause 15 further comprising a memory module configured for allocating additional memory to support the modified GOP structures to support a longer reference picture list.
29. An apparatus comprising:
   a. a non-transitory memory for storing an application, the application for:
      i. a separating module configured for separating each interlaced frame of an interlaced video into a top field and a bottom field; and
      ii. an encoding module configured for encoding the interlaced video using a modified group of pictures structure including a top field and a bottom field in a reference list with a plurality of reference pictures; and
   b. a processing component coupled to the memory, the processing component configured for processing the application.
30. The apparatus of clause 29 wherein if a current block in a picture includes only pixels in a field and the block has a plurality of reference field pictures as reference pictures in a reference list, then at least one of the reference field pictures is from the top field of a frame and at least one of the reference field pictures is from the bottom field of the frame or another frame.
31. The apparatus of clause 29 wherein the reference field pictures of a current picture in a reference list closest in time to the current picture include a top field picture and a bottom field picture.
32. The apparatus of clause 29 wherein the modified group of pictures structure applies to high efficiency video coding version 1 when all pictures in a sequence are field structure pictures.
33. The apparatus of clause 29 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.
34. The apparatus of clause 29 wherein the modified group of pictures structure is used for random access field sequences.
35. The apparatus of clause 29 wherein the modified group of pictures structure is used for low delay field sequences.
36. The apparatus of clause 29 wherein the modified group of pictures structure for random access field sequences has a group of pictures size of 16 field pictures.
37. The apparatus of clause 36 wherein the two nearest reference pictures of the current picture which are before the current picture, if available, include a top field picture and a bottom field picture.
38. The apparatus of clause 36 wherein the two nearest reference pictures of the current picture which are after the current picture, if available, include a top field picture and a bottom field picture.
39. The apparatus of clause 29 wherein the modified group of pictures structure for low delay field sequences has a group of pictures size of 8 field pictures.
40. The apparatus of clause 29 wherein the modified group of pictures structure comprises an alternative modified group of pictures structure for random access field sequences has a group of pictures size of 16 field pictures.
41. The apparatus of clause 29 wherein the modified group of pictures structure comprises a breadth-first modified group of pictures structure for random access field sequences has a group of pictures size of 16 field pictures.
42. The apparatus of clause 29 further comprising allocating additional memory to support the modified GOP structures to support a longer reference picture list.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of performing inter field prediction programmed in a memory of a device comprising:
a. separating each interlaced frame of an interlaced video into a top field and a bottom field; and
b. encoding the interlaced video using a modified group of pictures structure including a top field and a bottom field in a reference list with a plurality of reference pictures.

2. The method of claim 1 wherein if a current block in a picture includes only pixels in a field and the block has a plurality of reference field pictures in a reference picture list, then at least one of the reference field pictures is from the top field of a frame and at least one of the reference field pictures is from the bottom field of the frame or another frame.

3. The method of claim 2 wherein the reference field pictures of a current picture in a reference picture list closest in time to the current picture include a top field picture and a bottom field picture.

4. The method of claim 1 wherein the modified group of pictures structure applies to high efficiency video coding version 1 when all pictures in a sequence are field structure pictures.

5. The method of claim 1 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.

6. The method of claim 1 wherein the modified group of pictures structure is used for random access field sequences.

7. The method of claim 1 wherein the modified group of pictures structure is used for low delay field sequences.

8. The method of claim 1 wherein the modified group of pictures structure for random access field sequences has a group of pictures size of 16 field pictures.

9. The method of claim 8 wherein the two nearest reference pictures of the current picture which are before the current picture, if available, include a top field picture and a bottom field picture.

10. The method of claim 8 wherein the two nearest reference pictures of the current picture which are after the current picture, if available, include a top field picture and a bottom field picture.

11. The method of claim 1 wherein the modified group of pictures structure for low delay field sequences has a group of pictures size of 8 field pictures.

12. The method of claim 1 wherein the modified group of pictures structure comprises an alternative modified group of pictures structure for random access field sequences has a group of pictures size of 16 field pictures.

13. The method of claim 1 wherein the modified group of pictures structure comprises a breadth-first modified group of pictures structure for random access field sequences has a group of pictures size of 16 field pictures.

14. The method of claim 1 further comprising allocating additional memory to support the modified GOP structures to support a longer reference picture list.

15. A system for performing inter field prediction programmed in a memory of a device comprising:
a. a separating module configured for separating each interlaced frame of an interlaced video into a top field and a bottom field; and
b. an encoding module configured for encoding the interlaced video using a modified group of pictures structure including a top field and a bottom field in a reference list with a plurality of reference pictures.

16. The system of claim 15 wherein if a current block in a picture includes only pixels in a field and the block has a plurality of reference field pictures as reference pictures in a reference picture list, then at least one of the reference field pictures is from the top field of a frame and at least one of the reference field pictures is from the bottom field of the frame or another frame.

17. The system of claim 16 wherein the reference field pictures of a current picture in a reference picture list closest in time to the current picture include a top field picture and a bottom field picture.

18. The system of claim 15 wherein the modified group of pictures structure applies to high efficiency video coding version 1 when all pictures in a sequence are field structure pictures.

19. The system of claim 15 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.

20. The system of claim 15 wherein the modified group of pictures structure is used for random access field sequences.

21. The system of claim 15 wherein the modified group of pictures structure is used for low delay field sequences.

22. The system of claim 15 wherein the modified group of pictures structure for random access field sequences has a group of pictures size of 16 field pictures.

23. The system of claim 22 wherein the two nearest reference pictures of the current picture which are before the current picture, if available, include a top field picture and a bottom field picture.

24. The system of claim 22 wherein the two nearest reference pictures of the current picture which are after the current picture, if available, include a top field picture and a bottom field picture.

25. The system of claim 15 wherein the modified group of pictures structure for low delay field sequences has a group of pictures size of 8 field pictures.

26. The system of claim 15 wherein the modified group of pictures structure comprises an alternative modified group of pictures structure for random access field sequences has a group of pictures size of 16 field pictures.

27. The system of claim 15 wherein the modified group of pictures structure comprises a breadth-first modified group of pictures structure for random access field sequences has a group of pictures size of 16 field pictures.

28. The system of claim 15 further comprising a memory module configured for allocating additional memory to support the modified GOP structures to support a longer reference picture list.

29. An apparatus comprising:
a. a non-transitory memory for storing an application, the application for:
i. a separating module configured for separating each interlaced frame of an interlaced video into a top field and a bottom field; and
ii. an encoding module configured for encoding the interlaced video using a modified group of pictures structure including a top field and a bottom field in a reference list with a plurality of reference pictures; and
b. a processing component coupled to the memory, the processing component configured for processing the application.

30. The apparatus of claim 29 wherein if a current block in a picture includes only pixels in a field and the block has a plurality of reference field pictures as reference pictures in a reference list, then at least one of the reference field pictures is from the top field of a frame and at least one of the reference field pictures is from the bottom field of the frame or another frame.

31. The apparatus of claim 29 wherein the reference field pictures of a current picture in a reference list closest in time to the current picture include a top field picture and a bottom field picture.

32. The apparatus of claim 29 wherein the modified group of pictures structure applies to high efficiency video coding version 1 when all pictures in a sequence are field structure pictures.

33. The apparatus of claim 29 wherein the modified group of pictures structure applies to high efficiency video coding extensions or other versions of high efficiency video coding for field picture or field block coding where a current picture is a field structured picture, or the current picture is a frame structured picture and the current block is encoded as two field blocks.

34. The apparatus of claim 29 wherein the modified group of pictures structure is used for random access field sequences.

35. The apparatus of claim 29 wherein the modified group of pictures structure is used for low delay field sequences.

36. The apparatus of claim 29 wherein the modified group of pictures structure for random access field sequences has a group of pictures size of 16 field pictures.

37. The apparatus of claim 36 wherein the two nearest reference pictures of the current picture which are before the current picture, if available, include a top field picture and a bottom field picture.

38. The apparatus of claim 36 wherein the two nearest reference pictures of the current picture which are after the current picture, if available, include a top field picture and a bottom field picture.

39. The apparatus of claim 29 wherein the modified group of pictures structure for low delay field sequences has a group of pictures size of 8 field pictures.

40. The apparatus of claim 29 wherein the modified group of pictures structure comprises an alternative modified group of pictures structure for random access field sequences has a group of pictures size of 16 field pictures.

41. The apparatus of claim 29 wherein the modified group of pictures structure comprises a breadth-first modified group of pictures structure for random access field sequences has a group of pictures size of 16 field pictures.

42. The apparatus of claim 29 further comprising allocating additional memory to support the modified GOP structures to support a longer reference picture list.
